(19) United States
(12) Patent Application Publication
(10) Pub. No.: US 2012/0156483 A1
(43) Pub. Date: Jun. 21, 2012

(54) ASHESIVE TAPE OR SHEET, AND BASE MATERIAL THEREFOR

(75) Inventors: Yuta Shimazaki, Ibaraki-shi (JP); Eiichi Imoto, Ibaraki-shi (JP); Kunio Nagasaki, Ibaraki-shi (JP)

(73) Assignee: NITTO DENKO CORPORATION, Ibaraki-shi, Osaka (JP)

(21) Appl. No.: 13/392,738

(22) PCT Filed: Aug. 26, 2010
(86) PCT No.: PCT/JP2010/064534

§ 371 Date: Feb. 27, 2012

(30) Foreign Application Priority Data
Aug. 28, 2009 (JP) 2009-198387

(51) Int. Cl. B32B 7/12; B05D 5/10; B05D 3/06

(52) U.S. Cl. 428/343; 427/516

(57) ABSTRACT

An object of the present invention is to obtain a pressure-sensitive adhesive tape or pressure-sensitive adhesive sheet which is capable of free design of a pressure-sensitive adhesive and is peelable after use without adding special components to the pressure-sensitive adhesive, and to obtain a base material for use in such a pressure-sensitive adhesive tape or pressure-sensitive adhesive sheet. The base material for pressure-sensitive adhesive tape or pressure-sensitive adhesive sheet according to the present invention, the base material being a composite film containing a urethane polymer having an acryloyl group at its molecular chain end and a (meth)acrylic polymer, in which the composite film has a water absorption ratio of 5% or more. A (meth)acrylic monomer for forming the (meth)acrylic polymer preferably contains at least one compound selected from the group consisting of (meth)acrylic acid and (meth)acryloylmorpholine.

### TECHNICAL FIELD

The present invention relates to a base material for use in pressure-sensitive adhesive tapes, pressure-sensitive adhesive sheets, and the like, which the base material is a composite film containing an acrylic polymer and a urethane polymer. Particularly, it relates to a base material capable of reducing adhesive force by the contact with water.

### BACKGROUND ART

In general, a pressure-sensitive adhesive tape is used for fixing and bonding an object or the like and a strong adhesive force is required in uses except a special use where re-peelability is required.

However, there is a field where an adherend is required to be subjected to recycling after a pressure-sensitive adhesive tape is used. In this case, it becomes necessary to peel the pressure-sensitive adhesive tape at a desired time after use.

As a pressure-sensitive adhesive tape re-peelable after use, for example, JP-A-63-298274 (Patent Document 1) discloses a pressure-sensitive adhesive tape capable of being peeled and removed through wetting it with water after use, which is achieved by incorporating a water-swelling polymer into a pressure-sensitive adhesive layer thereof. However, since the pressure-sensitive adhesive tape is constituted so that the peelability is exhibited by wetting the pressure-sensitive adhesive with water, a sufficient adhesive force cannot be secured at usual use.

Moreover, owing to further requirement of enhanced functionality in recent years, various additives are frequently used in pressure-sensitive adhesives. However, when water-peelable performance such as a water-swelling property is imparted to the pressure-sensitive adhesives themselves, the types of the pressure-sensitive adhesives to be used are limited and thus degree of freedom in the design of the pressure-sensitive adhesives is to be limited.

### RELATED ART

### Patent Document

Patent Document 1: JP-A-63-298274

### DISCLOSURE OF INVENTION

### Problems to Be Solved by the Invention

The present invention is contrived for solving the above problems. An object of the present invention is to obtain a pressure-sensitive adhesive tape or pressure-sensitive adhesive sheet which is capable of free design of a pressure-sensitive adhesive and is peelable after use without adding special components to the pressure-sensitive adhesive, and to obtain a base material for use in such a pressure-sensitive adhesive tape or pressure-sensitive adhesive sheet.

### Means for Solving the Problems

A base material of the present invention is a composite film containing a urethane polymer having an acryloyl group at its molecular chain end (hereinafter, sometimes referred to as “acryloyl group-ended urethane polymer”) and a (meth)acrylic polymer, in which the composite film has a water absorption ratio of 5% or more.

The base material consists of the composite film.

In the present invention, a (meth)acrylic monomer for forming the (meth)acrylic polymer preferably contains at least one compound selected from the group consisting of (meth)acrylic acid and (meth)acryloylmorpholine.

In the present invention, the (meth)acrylic monomer for forming the (meth)acrylic polymer preferably contains (meth)acrylic acid and isobornyl acrylate, or (meth)acryloylmorpholine and isobornyl acrylate.

In the present invention, a content of the urethane polymer is preferably 40 parts by weight or more based on 100 parts by weight of total weight of the urethane polymer and the (meth)acrylic polymer.

The pressure-sensitive adhesive tape or pressure-sensitive adhesive sheet of the present invention contains a pressure-sensitive adhesive layer on one surface of the above base material.

The process for producing a base material for pressure-sensitive adhesive tape or pressure-sensitive adhesive sheet of the present invention as a composite film, contains: a step of reacting a polyol with a polyisocyanate in one or more (meth)acrylic monomers to form a urethane polymer, and a step of applying a mixture containing the (meth)acrylic monomer and the urethane polymer on a support and irradiating the mixture with light to form an acrylic polymer, in which the composite film having a water absorption ratio of 5% or more is obtained.

In the producing process of the present invention, the (meth)acrylic monomer preferably contains at least one compound selected from the group consisting of (meth)acrylic acid and (meth)acryloylmorpholine.

According to the present invention, the use of the base material having a water-swelling property makes it possible to reduce adhesive force of the pressure-sensitive tape or pressure-sensitive adhesive sheet.

### Effects of the Invention

According to the present invention, there can be realized a pressure-sensitive adhesive tape or pressure-sensitive adhesive sheet which is capable of free design of a pressure-sensitive adhesive and is peelable after use without adding special components to the pressure-sensitive adhesive, and can be realized a base material for use in such a pressure-sensitive adhesive tape or pressure-sensitive adhesive sheet.

### Embodiments for Carrying Out the Invention

The following will explain the present invention in detail.

The base material of the present invention is constituted by a composite film alone. The composite film contains a urethane polymer and a (meth)acrylic polymer. In the present invention, the composite film is, for example, formed by irradiating a mixture containing the urethane polymer and a (meth)acrylic monomer as main components with a radiation ray or the like.

In the present invention, in the case of referring to a “film”, the concept includes a sheet and also, in the case of referring to a “sheet”, the concept includes a film.

The urethane polymer is obtained by reacting a polyol with a polyisocyanate. In the reaction of the hydroxyl group of the polyol with the polyisocyanate, the reaction may be performed with a catalyst or without a catalyst. In the case where a catalyst is used, a catalyst commonly used in a urethane reaction can be used and examples thereof include dibutyltin dilaurate, tin octanoate, and 1,4-diazabicyclo[2,2,2]octane.

As the polyol for use in the present invention, one having two or more hydroxyl groups in one molecule thereof is desired. Examples of a low-molecular-weight polyol include dihydric alcohols such as ethylene glycol, diethylene glycol, propylene glycol, butylene glycol, and hexamethylene glycol; and trihydric or tetrahydric alcohols such as trimethylolpropane, glycerin, and pentaerythritol.

Examples of a high-molecular-weight polyol include polyether polyols, polyester polyols, acryl polyols, epoxy polyols, carbonate polyols, and caprolactone polyols.

Of these, polyether polyols, polyester polyols, and carbonate polyols are preferably used.

Examples of the polyether polyols include polyethylene glycol, polypropylene glycol, and polytetramethylene glycol (PTMG). Examples of the polyester polyols include polycondensates of an alcohol such as the above dihydric alcohols, dipropylene glycol, 1,4-butanediol, 1,6-hexanediol, or neopentyl glycol with a dibasic acid such as adipic acid, azelaic acid, or sebacic acid. In addition, there are lactone-based ring-opened polymer polyols such as a polycaprolactone, polycarbonate diols, and the like.

Moreover, examples of the acryl polyols include copolymers of hydroxyl group-containing monomers such as hydroxyethyl(meth)acrylate and hydroxypropyl(meth)acrylate, and also copolymers of a hydroxyl group-containing compound with an acrylic monomer. Examples of the epoxy polyols include amine-modified epoxy resins.

In the present invention, the above polyols can be used singly or in combination, in consideration of solubility in (meth)acrylic monomers, reactivity with isocyanates, and the like. For example, in the case where strength is necessary, a cross-linked structure with a triol can be introduced. In the case where elongation is regarded as important, it is preferred to use a polyol having a large molecular weight singly. Moreover, polyether polyols are generally inexpensive and have a good water resistance and polyester polyols have a high strength. In the present invention, depending on uses and purposes, the kind and amount of the polyols can be freely selected, and also, from the viewpoint of characteristics of a support to be applied on, reactivity with isocyanates, compatibility with acryls, and the like, the kind, molecular weight, and amount of the polyols can be appropriately selected.

Examples of the polyisocyanates include aromatic, aliphatic, and alicyclic diisocyanates, and dimers and trimers of these diisocyanates. Examples of the aromatic, aliphatic, and alicyclic diisocyanates include tolylene diisocyanate, diphenylmethane diisocyanate, hexamethylene diisocyanate, xylylene diisocyanate, hydrogenated xylylene diisocyanate (HXDI), isophorone diisocyanate, hydrogenated diphenylmethane diisocyanate, 1,5-naphthylene diisocyanate, 1,3-phenylene diisocyanate, 1,4-phenylene diisocyanate, butane-1,4-diisocyanate, 2,2,4-trimethylhexamethylene diisocyanate, 2,4,4-trimethylhexamethylene diisocyanate, cyclohexane-1,4-diisocyanate, dicyclohexylmethane-4,4-diisocyanate, 1,3-bis(isocyanatomethyl)cyclohexane, methylcyclohexane diisocyanate, and m-tetramethylxylylene diisocyanate. Moreover, dimes and trimers thereof and polyphenylmethane diisocyanate can be used. As the trimers, isocyanurate type, biuret type, allophanate type, and the like are mentioned and can be appropriately used.

These polyisocyanates can be used singly or in combination. From the viewpoint of urethane reactivity, solubility in (meth)acrylic monomers, reactivity with a hydroxyl group, and the like, the kind, combination, and the like of the polyisocyanates may be appropriately selected.

In the present invention, the urethane polymer is obtained using a urethane polymer precursor and the urethane polymer precursor is obtained by reacting a polyol with a polyisocyanate. The amounts of the polyol component and polyisocyanate component to be used for forming the urethane polymer precursor are not particularly limited. However, for example, a ratio of the isocyanate group of the polyisocyanate to the hydroxyl group of the polyol, i.e., an NCO/OH ratio (equivalent ratio) is preferably 0.8 or more and 3.0 or less, further preferably 1.0 or more and 3.0 or less, and particularly preferably 1.1 or more and 2.0 or less. When the NCO/OH ratio (equivalent ratio) is less than 0.8, the molecular chain length of the urethane polymer cannot be sufficiently extended and cohesiveness of the urethane is prone to decrease. When the NCO/OH ratio (equivalent ratio) is more than 3.0, flexibility of the resulting film is prone to decrease. In this regard, considering the reaction with the hydroxyl group-containing (meth)acrylate-based compound, the NCO/OH ratio (equivalent ratio) is preferably 1.0 or more. Moreover, when the NCO/OH ratio (equivalent ratio) is more than 2.0, the elongation of the film is prone to decrease, 20% modulus is prone to increase, and flexibility as a film is prone to be insufficient.

A urethane polymer having an acryloyl group at its molecular chain end (acryloyl group-ended urethane polymer) can be, for example, obtained by reacting a urethane polymer having an isocyanate group at its molecular chain end (hereinafter sometimes referred to as an “isocyanate group-ended urethane polymer”) with a hydroxyl group-containing (meth)acrylate-based compound. In the present invention, it is preferred to add a hydroxyl group-containing (meth)acrylate, to the above urethane polymer precursor as the isocyanate group-ended urethane polymer.

Examples of the hydroxyl group-containing (meth)acrylate compound to be used include 2-hydroxyethyl(meth)acrylate, 2-hydroxypropyl(meth)acrylate, 2-hydroxybutyl(meth)acrylate, 4-hydroxybutyl(meth)acrylate, 2-hydroxyethylacryloyl phosphate, 2-(meth)acryloyloxyethyl-2-hydroxypropyl phthalate, 2-hydroxy-3-(meth)acryloyloxypropyl(meth)acrylate, caprolactone-modified 2-hydroxyethyl(meth)acrylate, pentaerythritol tri(meth)acrylate, dipentaerithritol penta(meth)acrylate, caprolactone-modified dipentaerythritol penta(meth)acrylate, caprolactone-modified pentaerythritol tri(meth)acrylate, ethylene oxide-modified dipentaerythritol penta(meth)acrylate, and ethylene oxide-modified pentaerythritol tri(meth)acrylate.

In the present invention, by adding the hydroxyl group-containing (meth)acrylate to the urethane polymer precursor (isocyanate group-ended urethane polymer), copolymerizability with an acrylic monomer is imparted to the molecular chain end of the urethane polymer, compatibility of the urethane component with the acrylic component is enhanced (transparency is improved), and S—S properties such as breaking strength can be also improved. In this regard, in order not to leave any NCO residue at the urethane polymer end, the amount of the hydroxyl group-containing (meth)acrylate compound to be used is preferably a prescribed amount. Namely, for example, the amount of the hydroxyl group-containing (meth)acrylate compound to be used is such an amount that the compound is added to the urethane polymer precursor having an NCO/OH ratio (equivalent ratio) of 1.1 or more and 2.0 or less so that the NCO/OH ratio (equivalent ratio) of the urethane polymer becomes 1.0.

The composite film of the present invention can be obtained, as mentioned above, by forming the isocyanate group-ended urethane polymer by a urethane reaction in the presence of a (meth)acrylic monomer, forming an acryloyl group-ended urethane polymer in the presence of the hydroxyl group-containing (meth)acrylate compound, and forming the (meth)acrylic polymer by irradiation with a radiation ray or the like.

The (meth)acrylic monomer for use in the formation of the composite film of the present invention is preferably one having a water-swelling property. In the present invention, (meth)acrylic acid and/or (meth)acryloylmorpholine having a water-swelling property and being capable of imparting toughness are preferably used.

The (meth)acrylic acid and/or (meth)acryloylmorpholine are preferably blended in an amount of 30 parts by weight or more, and more preferably, 50 parts by weight or more based on 100 parts by weight of whole acrylic component. By blending (meth)acrylic acid and/or (meth)acryloylmorpholine in an amount of 30 parts by weight or more based on 100 parts by weight of the whole acrylic component, the composite film having a prescribed water absorption ratio to be mentioned later can be obtained.

Examples of other (meth)acrylic monomers to be blended and used in the above (meth)acrylic monomers include methyl(meth)acrylate, ethyl(meth)acrylate, propyl(meth)acrylate, butyl(meth)acrylate, pentyl(meth)acrylate, hexyl(meth)acrylate, 2-ethylhexyl(meth)acrylate, octyl(meth)acrylate, isooctyl(meth)acrylate, nonyl(meth)acrylate, isononyl(meth)acrylate, and isobomyl(meth)acrylate. They can be used singly or in combination of two or more thereof.

With regard to the (meth)acrylic monomers, it is preferred that the kind, combination, amount to be used, and the like are appropriately determined in consideration of compatibility with urethane, polymerizability at curing with a radiation ray or the like and characteristics of the high-molecular-weight compounds obtained. The amount of the (meth)acrylic monomer to be used preferably falls within the range of 5% by weight or more and 60% by weight or less in the mixture containing the urethane polymer and the (meth)acrylic monomer as main components. When the amount of the (meth)acrylic monomer to be used is less than 5% by weight, there may arise a problem in tensile elasticity and stress of the composite film obtained. When the amount is more than 60% by weight, there may arise a problem in the elongation characteristic of the composite film.

In the present invention, together with the above (meth)acrylic monomers, monomers such as vinyl acetate, vinyl propionate, styrene, acrylamide, methacrylamide, mono- or di-esters of maleic acid and derivatives thereof, N-methylolacrylamide, glycidyl acrylate, glycidyl methacrylate, N,N-dimethylaminoethyl acrylate, N,N-dimethylaminopropylmethacrylamide, 2-hydroxypropyl acrylate, N,N-dimethylacrylamide, N,N-diethylacrylamide, imide acrylate, N-vinylpyrrolidone, oligoester acrylate, and ε-caprolactone acrylate may be used or may be copolymerized. In this regard, it is preferred that the kind and amount to be used of these monomers are appropriately determined in consideration of properties of the composite film and the like.

Moreover, within a range where the properties are not impaired, another polyfunctional monomer can be added as a cross-linking agent according to needs. Examples of the polyfunctional monomer include trimethylolpropane tri(meth)acrylate, and dipentaerythritol hexa(meth)acrylate. The amount of the polyfunctional monomer to be used is preferably 1 part by weight or more and 20 parts by weight or less based on 100 parts by weight of the (meth)acrylic monomers.

In the present invention, the ratio of the urethane polymer is preferably 40 parts by weight or more based on 100 parts by weight of total of the urethane polymer and the (meth)acrylic polymer. When the ratio of the urethane polymer is less than 40 parts by weight, the elongation of the composite film may decrease and its handling is prone to be difficult. When the ratio of the urethane polymer is 40 parts by weight or more, flexibility of the composite film may be improved and followability to uneven surface may become good.

In the composite film, if necessary, additives to be usually used, for example, a UV absorbent, an antiaging agent, a filler, a pigment, a colorant, a flame retardant, an antistatic agent, and the like can be added within a range where the effects of the present invention is not inhibited. These additives are used in ordinary amounts depending on the kind thereof. These additives may be added before the polymerization reaction of the polyisocyanate with the polyol in advance or may be added before the polymerization of each of the urethane polymer and the acrylic monomer.

Moreover, in order to adjust viscosity at coating, a small amount of a solvent may be added. The solvent can be appropriately selected from solvents to be usually used, but examples thereof include ethyl acetate, toluene, chloroform, and dimethylformamide.

The composite film of the present invention can be, for example, obtained by applying a coating solution for the composite film on a release-treated surface of a release-treated polyethylene terephthalate film, placing a transparent separator or the like thereon, curing the obtained material through irradiation with a radiation ray such as an ultraviolet ray or an electron beam from above to form a film, and subsequently removing the release-treated polyethylene terephthalate film and the separator. In this regard, a pressure-sensitive adhesive layer may be provided on the releasable base material such as the release-treated polyethylene terephthalate, and the composite film may be formed thereon. Alternatively, after the composite film is formed, a pressure-sensitive adhesive layer prepared separately may be laminated thereon to prepare a pressure-sensitive adhesive tape or pressure-sensitive adhesive sheet of pressure-sensitive adhesive layer/composite film. In the present invention, the pressure-sensitive adhesive tape or pressure-sensitive adhesive sheet has a pressure-sensitive adhesive layer only on one surface.

In the present invention, the composite film can be, for example, formed by reacting a polyol with a polyisocyanate in a (meth)acrylic monomer using the (meth)acrylic monomer as a diluent to form a urethane polymer, applying a mixture containing the (meth)acrylic monomer and the urethane polymer as main components on a release-treated film or the like, and curing the mixture through irradiation with an ionizing radiation ray such as α-ray, β-ray, γ-ray, a neutron ray, or an electron beam, a radiation ray such as an ultraviolet ray, or the like according to the kind of a photopolymerization initiator or the like.

Specifically, the composite film can be obtained by dissolving a polyol in a (meth)acrylic monomer, then adding a polyisocyanate or the like and reacting it with the polyol to adjust the viscosity, further adding a hydroxyl group-containing (meth)acrylate compound, applying the mixture to a support such as a polyethylene terephthalate film, followed by curing by using a low-pressure mercury lamp or the like. In this process, the (meth)acrylic monomer may be added at once during the urethane synthesis or may be added in several times. Also, after the polyisocyanate is dissolved in the (meth)acrylic monomer, the polyol may be reacted therewith. According to the process, since the molecular weight is not limited and a high-molecular-weight polyurethane can be also generated, the molecular weight of the urethane finally obtained can be designed to be an any desired one.

On this occasion, in order to avoid inhibition of polymerization due to oxygen, a release-treated sheet may be placed on the mixture of the urethane polymer and the (meth)acrylic monomer applied on the support to block oxygen, or the base material may be placed in a vessel filled with an inert gas to lower oxygen concentration.

In the present invention, the kind of the radiation ray or the like, the kind of the lamp to be used for irradiation, and the like can be appropriately selected, and low-pressure lamps such as a fluorescent chemical lamp, a black light, and a bactericidal lamp, high-pressure lamps such as a metal halide lamp and a high-pressure mercury lamp, LED lamps, EB irradiation apparatus, and the like can be used.

The irradiance level of the ultraviolet ray or the like can be arbitrarily set according to the required properties of the film. In general, the irradiance level of the ultraviolet ray is 100 to 5,000 mJ/cm², preferably 1,000 to 4,000 mJ/cm², and further preferably 2,000 to 3,000 mJ/cm². When the irradiance level of the ultraviolet ray is less than 100 mJ/cm², a sufficient conversion may not be obtained. When it is more than 5,000 mJ/cm², deterioration may be caused.

Moreover, the temperature at the ultraviolet light irradiation is not particularly limited and can be arbitrarily set. However, since a termination reaction caused by heat of polymerization is prone to occur and a property decrease tends to be caused when the temperature is too high, the temperature is usually 70° C. or lower, preferably 50° C. or lower, and further preferably 30° C. or lower.

A photopolymerization initiator is contained in the mixture containing the urethane polymer and the (meth)acrylic monomer as main components. As the photopolymerization initiator, use is preferably made of benzoin ethers such as benzoin methyl ether, benzoin isopropyl ether, and 2,2-dimethoxy-1,2-diphenylethane-1-one; substituted benzoin ethers such as anisole methyl ether; substituted acetophenones such as 2,2-diethoxyacetophenone, 2,2-dimethoxy-2-phenylacetophenone, and 1-hydroxy-cyclohexyl-phenyl-ketone; substituted α-ketols such as 2-methyl-2-hydroxypropiophenone; aromatic sulfonyl chlorides such as 2-naphthalenesulfonyl chloride; photoactive oximes such as 1-phenyl-1,1-propanedione-2-(o-ethoxycarbonyl)-oxime; acylphosphine oxides such as 2,4,6-trimethylbenzoyl-dipenyl-phosphine oxide and bis(2,4,6-trimethylbenzoyl-phenylphosphine oxide); and the like.

The thickness of the composite film of the present invention can be appropriately selected according to purposes and the like. In general, the thickness is 5 to 500 μm, and preferably about 10 to 300 μm.

The pressure-sensitive adhesive tape or pressure-sensitive adhesive sheet of the present invention can be obtained by forming a pressure-sensitive adhesive layer on one surface of a base material that is the composite film. The pressure-sensitive adhesive composition is not particularly limited and a common one such as acrylic one or rubber one can be used. A method of forming the pressure-sensitive adhesive layer is also not particularly limited, and a method of applying a solvent-type or emulsion-type pressure-sensitive adhesive directly on the base material and drying it, a method of applying such a pressure-sensitive adhesive on a release paper to form a pressure-sensitive adhesive layer in advance and attaching the pressure-sensitive adhesive layer on the base material, or the like can be adopted. A method of applying a radiation-curable pressure-sensitive adhesive on the base material and curing the base material and the pressure-sensitive adhesive layer simultaneously by irradiating both of the pressure-sensitive adhesive layer and the base material with a radiation ray to form the pressure-sensitive adhesive layer can be also adopted. In this case, the pressure-sensitive adhesive layer and the composite film layer can be applied so as to be a multilayer constitution.

The thickness of the pressure-sensitive adhesive layer is not particularly limited and can be arbitrarily set. However, usually, the thickness is preferably 3 to 100 μm, further preferably 10 to 50 μm, and particularly preferably about 10 to 30 μm.

The pressure-sensitive adhesive tape or pressure-sensitive adhesive sheet of the present invention can swell through water absorption of the composite film to enhance flexibility of the base material and thus can be easily peeled off from an adherend after use. In the present invention, the water absorption ratio of the composite film is necessarily 5% or more, preferably 10% or more, and further preferably 12% or more. When the water absorption ratio of the composite film is less than 5%, an effect of lowering peel force after the contact with water is small since an effect of water absorption is small.

With regard to the base material for use in the formation of the pressure-sensitive adhesive tape or pressure-sensitive adhesive sheet of the present invention, the flexibility thereof can be evaluated as initial modulus. As the flexibility of the base material, the initial modulus (20% elongation modulus) after water absorption of the base material is preferably 1.5 MPa or less, and further preferably 1.4 MPa or less. The 20% elongation modulus herein means a stress required for stretching the base material by 20%.

The base material of the present invention has a breaking strength of preferably 10 N/mm² or more and further preferably 20 N/mm² or more. Moreover, the base material of the present invention has a fracture elongation (breaking elongation) of preferably 100% or more, and further preferably 200% or more. When the breaking strength of the base material is less than 10 N/mm² or the breaking elongation is less than 100%, there is a possibility that the pressure-sensitive adhesive tape or pressure-sensitive adhesive sheet may break off at use.

In the present invention, the breaking strength is a stress necessary for breaking the base material or the like. Specifically, a tensile force is gradually applied to a base material, a force at the time when the base material is broken is determined, and the breaking strength is shown as a value obtained by converting the force into a stress per unit area. Moreover, the fracture elongation (breaking elongation) means a ratio of elongation (elongation ratio) until the base material is broken. Specifically, the fracture elongation is shown as a value (unit: %) obtained by dividing an elongated length until a base material is broken when a tensile force is applied to the base material by the original length.

The pressure-sensitive adhesive tape or pressure-sensitive adhesive sheet of the present invention desirably has a peel strength against SUS 304 plate (stainless steel) of 16 N/25 mm or more, and preferably 18 N/25 mm or more. Moreover, after the attachment to SUS 304 plate, the peel strength after immersion in water at 25° C. for 1 hour is desirably 12 N/25 mm or less, and preferably 10 N/25 mm or less. From the viewpoint of security of a sufficient adhesive force at use of attachment and easy peelability after use, the above range is desirable.

Since the pressure-sensitive adhesive tape or pressure-sensitive adhesive sheet of the present invention uses a base material having a water-swelling property, the peel force is reduced by swelling the base material and thus the tape or sheet can be easily peeled. Therefore, according to the present invention, a pressure-sensitive adhesive tape or pressure-sensitive adhesive sheet easily peelable after use can be realized without changing the design of a pressure-sensitive adhesive itself. Namely, according to the present invention, since a desirable pressure-sensitive adhesive can be used freely without particular limitation, the adhesive force at use can be sufficiently secured and also the tape or sheet can be easily peeled through swelling after use.

For example, the pressure-sensitive adhesive tape or pressure-sensitive adhesive sheet having a pressure-sensitive adhesive layer on one surface of the base material can be used with attaching the pressure-sensitive adhesive layer positioned at the outermost layer of the pressure-sensitive adhesive tape or pressure-sensitive adhesive sheet to an adherend and, after use, the pressure-sensitive adhesive tape or pressure-sensitive adhesive sheet can be peeled off from the adherend through immersion in water.

Moreover, according to the present invention, since the base material can be formed by irradiation with a radiation ray such as an ultraviolet ray or an electron beam, the process is simple and convenient. In addition, since it can be formed without needing any solvent, the process is also excellent from the viewpoint of environmental protection. Furthermore, according to the present invention, by appropriately selecting the kinds and amounts of the polyol, polyisocyanate, and (meth)acrylic monomer, a composite film having arbitrary values of physical properties can be obtained. Also, since the base material of the present invention has a good followability to curved surface, in the case where it is used for production of the pressure-sensitive adhesive tape or pressure-sensitive adhesive sheet, exfoliation is not generated even when the adherend is subjected to flexion movement. Furthermore, since the base material has a good processability, there is also an advantage that secondary processing such as press working can be easily performed.

### EXAMPLES

The following will describe the present invention in detail with reference to Examples but the present invention is not limited thereto.

### Example 1

Into a reaction vessel provided with a cooling tube, a thermometer, and a stirring apparatus, there were charged 100 parts by weight of acryloylmorpholine (ACMO) (manufactured by Kohjin Co., Ltd.) as a (meth)acrylic monomer, 72.8 parts by weight of poly(tetramethylene) glycol (PTMG) (number-average molecular weight: 650, manufactured by Mitsubishi Chemical Corporation) as a polyol, and 0.01 parts by weight of dibutyltin dilaurate (DBTL) as a catalyst. With stirring, 27.2 parts by weight of hydrogenated xylylene diisocyanate (HXDI) (manufactured by Mitsui Chemicals Polyurethane, Inc.) as a polyisocyanate was added dropwise thereto, followed by reacting at 65° C. for 3 hours to form a urethane polymer having an isocyanate group at the molecular chain end (isocyanate group-ended urethane polymer). Then, 6.5 parts by weight of 2-hydroxyethyl acrylate (HEA) (manufactured by Osaka Organic Chemical Industry Ltd.) was added dropwise thereto, followed by further reacting at 65° C. for 1 hour to obtain an acryloyl group-ended urethane polymer-acrylic monomer mixture. Thereafter, 0.30 parts by weight of 2,2-dimethoxy-1,2-diphenylethane-1-one (IRGACURE651, manufactured by Ciba Japan, Inc.) as a photopolymerization initiator was added thereto to obtain a coating solution for composite film. Incidentally, with regard to the used amounts of the polyisocyanate component and the polyol component in the isocyanate group-ended urethane polymer, the NCO/OH ratio (equivalent ratio) was 1.25.

The resulting coating solution for composite film was applied on a release-treated surface of a release-treated polyethylene terephthalate film (PET film) having a thickness of 38 μm so that the thickness after curing became 200 μm. A release-treated polyethylene terephthalate (PET) film (thickness: 38 μm) was overlaid thereon to cover as a separator, and the covered separator surface was then irradiated with an ultraviolet ray (illuminance: 290 mW/cm², light intensity: 4,600 mJ/cm²) using a metal halide lamp to achieve curing, thereby forming a composite film (provided with the separator) on the release-treated PET film.

The separator was removed from the resulting composite film (base material) and an acrylic pressure-sensitive adhesive No. 5915 (manufactured by Nitto Denko Corporation) was laminated on that surface to prepare a single-coated pressure-sensitive adhesive tape.

For the resulting composite film and single-coated pressure-sensitive adhesive tape, the water absorption ratio, breaking elongation, breaking strength, peel strength (before immersion, after immersion), and initial modulus (20% modulus) after immersion were measured and evaluated. In this regard, measurement methods and the like are described below. The results are shown in Table 1.

### Example 2, Example 3, Comparative Example 1, and Comparative Example 2

Each base material was prepared in the same manner as in Example 1 except that, in Example 1, the kind and blend ratio of the acrylic monomer as an acrylic component were changed as shown in Tables 1 and 2. In the case where two or more kinds of (meth)acrylic monomers were added, they were added at the same timing. Moreover, using the resulting base material, each single-coated pressure-sensitive adhesive tape was prepared in the same manner as in Example 1.

For the resulting base material and single-coated pressure-sensitive adhesive tape, the measurement and evaluation the same as in Example 1 were performed. The results are shown in Tables 1 and 2.

### Example 4

Into a reaction vessel provided with a cooling tube, a thermometer, and a stirring apparatus, there were charged 75 parts by weight of acryloylmorpholine (ACMO) (manufactured by Kohjin Co., Ltd.) as a (meth)acrylic monomer, 72.8 parts by weight of poly(tetramethylene) glycol (PTMG) (number-average molecular weight: 650, manufactured by Mitsubishi Chemical Corporation) as a polyol, and 0.01 parts by weight of dibutyltin dilaurate (DBTL) as a catalyst. With stirring, 27.2 parts by weight of hydrogenated xylylene diisocyanate (HXDI) (manufactured by Mitsui Chemicals Polyurethane, Inc.) as a polyisocyanate was added dropwise thereto, followed by reacting at 65° C. for 3 hours to form a urethane polymer having an isocyanate group at the molecular chain end (isocyanate group-ended urethane polymer). Then, 6.5 parts by weight of 2-hydroxyethyl acrylate (HEA) (manufactured by Osaka Organic Chemical Industry Ltd.) was added dropwise thereto, followed by further reacting at 65° C. for 1 hour to obtain an acryloyl group-ended urethane polymer-acrylic monomer mixture. Thereafter, 0.30 parts by weight of 2,2-dimethoxy-1,2-diphenylethane-1-one (IRGACURE651, manufactured by Ciba Japan, Inc.) as a photopolymerization initiator and 25 parts by weight of acrylic acid (AA) (manufactured by Toagosei Co., Ltd.) as a (meth)acrylic monomer were added thereto to obtain a coating solution for composite film. Incidentally, with regard to the used amounts of the polyisocyanate component and the polyol component in the isocyanate group-ended urethane polymer, the NCO/OH ratio (equivalent ratio) was 1.25.

The resulting coating solution for composite film was applied on a release-treated surface of a release-treated polyethylene terephthalate film (PET film) having a thickness of 38 μm so that the thickness after curing became 200 μm. A release-treated polyethylene terephthalate (PET) film (thickness: 38 μm) was overlaid thereon to cover as a separator, and the covered separator surface was then irradiated with an ultraviolet ray (illuminance: 290 mW/cm², light intensity: 4,600 mJ/cm²) using a metal halide lamp to achieve curing, thereby forming a composite film (provided with the separator) on the release-treated PET film.

The separator was removed from the resulting composite film (base material) and an acrylic pressure-sensitive adhesive No. 5915 (manufactured by Nitto Denko Corporation) was laminated on that surface to prepare a single-coated pressure-sensitive adhesive tape.

For the resulting composite film (base material) and single-coated pressure-sensitive adhesive tape, the water absorption ratio, breaking elongation, breaking strength, peel strength (before immersion, after immersion), and initial modulus (20% modulus) after immersion were measured and evaluated. In this regard, measurement methods and the like are described below. The results are shown in Table 1.

### Example 5 and Comparative Example 3

Each base material was prepared in the same manner as in Example 4 except that, in Example 4, the kind and used amount of the (meth)acrylic monomer as an acrylic component were changed as shown in Tables 1 and 2, and also each single-coated pressure-sensitive adhesive tape was prepared. Incidentally, with regard to the timing to add acrylic acid (AA) and isobornyl acrylate (IBXA) in Comparative Example 3, acrylic acid was charged into the reaction vessel together with the polyol, and isobornyl acrylate was added after the urethane reaction.

For the resulting base material and single-coated pressure-sensitive adhesive tape, the measurement and evaluation the same as in Example 4 were performed. The results are shown in Tables 1 and 2.

### Comparative Example 4

A base material was prepared in the same manner as in Example 1 except that, in Example 1, the kinds and used amounts of the acrylic component, urethane component, urethane end reaction agent, and catalyst were changed as shown in Table 2, and also a single-coated pressure-sensitive adhesive tape was prepared.

For the resulting base material and single-coated pressure-sensitive adhesive tape, the measurement and evaluation the same as in Example 1 were performed. The results are shown in Tables 2.

### (Evaluation Methods)

### (1) Evaluation of Mechanical Properties

For the resulting base material (composite film or the like), initial modulus (20% elongation modulus) after immersion, breaking elongation, and breaking strength were measured as evaluation of mechanical properties based on the following evaluation methods.

Namely, the base material (composite film or the like) provided with the release-treated PET film and the separator was cut into a size having a width of 1 cm and a length of 10 cm, the release-treated PET film and the separator were then removed and a tensile test was performed at a tensile rate of 200 mm/min, a distance between chucks of 50 mm, and room temperature (23° C.) using “Autograph AG-lkNG” (manufactured by Shimadzu Corporation) as a tension tester to determine a stress-strain curve.

A stress at the time when the film was broken was determined and taken as the breaking strength and a strain (elongation ratio) at the time when the film was broken was determined and taken as the breaking elongation.

Moreover, with regard to the initial modulus after immersion, the base material (composite film or the like) was immersed in water at 25° C. for 1 day, the base material was then taken out and water drops attached on the surface were removed by lightly putting a paper waste thereon. Then, a tensile test was performed to determine a stress-strain curve. As the initial modulus after immersion, a stress per unit area at the time when the base material was stretched by 20% was taken as the initial modulus (20% elongation fmodulus).

### (2) Evaluation of Water Absorption Ratio

The base material (composite film or the like) provided with the release-treated PET film and the separator was cut into a size having a width of 3 cm and a length of 3 cm, the release-treated PET film and the separator were then removed to prepare a test piece. The test piece was weighed and the weight was taken as “weight of the test piece before immersion”. Then, after immersed in water at 25° C. for 1 day, the test piece was taken out, water drops attached on the surface were removed by lightly putting a paper waste thereon, and the weight of the test piece was immediately measured. The weight was taken as “weight of the test piece after immersion”. The resulting numeric values were assigned to the following expression to calculate the water absorption ratio.

Water absorption ratio (%)=(Weight of the test piece after immersion/Weight of the test piece before immersion)×100-100

### (3) Evaluation of Adhesive Force

As an adherend, a surface-BA finished steel plate (one subjected to bright heat treatment after cold rolling) of SUS304 (stainless steel) having a thickness of 0.4 mm (hereinafter abbreviated as a “BA plate”) was cut into a size having a width of 40 mm and a length of 100 mm, and the BA plate was washed in accordance with JIS Z1541-7.2.1.3b and used as a test plate.

The single-coated pressure-sensitive adhesive tape obtained was cut into a size of 25 mm×100 mm and the release-treated PET film was peeled off to prepare a test tape. The pressure-sensitive adhesive layer surface of the test tape was overlaid to an edge part (40 mm side) of the test plate so that a part of the test tape was protruded from the edge part to form a play part and lightly attached thereto, one-way pressure bonding was then performed from above the test tape at a rate of about 300 mm per minute using a 5 kg roller.

After the pressure bonding, the whole was allowed to stand at room temperature for 24 hours and then the play part of the test tape was folded back at 90° and peeled from the test plate by about 10 mm. The test plate was held with the lower chuck and the play part of the test tape folded back at 90° was held with the upper chuck. With paying attention so that the folded part was perpendicular to the surface to which the test tape had been attached, peeling was continuously conducted under an atmosphere of 23° C. and 65%RH at a rate of 50±5 mm per minute and the peel strength was read out. The measurement was repeated three times and an average value thereof was taken as the peel strength before immersion.

Also, after the pressure bonding, the whole was allowed to stand at room temperature for 24 hours and then further immersed in water at 25° C. for 1 hour. Thereafter, the play part of the test tape was folded back at 90° and the peel strength was read out in the same manner as in the above and an average value was determined. The average value thereof was taken as the peel strength after immersion.

TABLE 1

| | | Example 1 | | Example 2 | | Example 3 | | Example 4 | | Example 5 | |
|---|---|---|---|---|---|---|---|---|---|---|---|
| Acrylic | (Meth)acrylic monomer | ACMO | (100 parts) | ACMO | (75 parts) | ACMO | (50 parts) | ACMO | (75 parts) | ACMO | (50 parts) |
| component | | | | IBXA | (25 parts) | IBXA | (50 parts) | AA | (25 parts) | AA | (50 parts) |
| Urethane | Polyol (PTMG) | 72.8 | parts | 72.8 | parts | 72.8 | parts | 72.8 | parts | 72.8 | parts |
| component | Polyisocyanate (HXDI) | 27.2 | parts | 27.2 | parts | 27.2 | parts | 27.2 | parts | 27.2 | parts |

| | | | | | | | | | | |
|---|---|---|---|---|---|---|---|---|---|---|
| Photopolymerization initiator (Irg651) | 0.3 | parts | 0.3 | parts | 0.3 | parts | 0.3 | parts | 0.3 | parts |
| Urethane end reaction additive (HEA) | 6.5 | parts | 6.5 | parts | 6.5 | parts | 6.5 | parts | 6.5 | parts |
| Catalyst (DBTL) | 0.01 | parts | 0.01 | parts | 0.01 | parts | 0.01 | parts | 0.01 | parts |

| Acrylic polymer (% by weight) | | 50 | 50 | 50 | 50 | 50 |
|---|---|---|---|---|---|---|
| Urethane polymer (% by weight) | | 50 | 50 | 50 | 50 | 50 |
| Water absorption ratio (%) | | 22.7 | 8.7 | 6.3 | 40.6 | 28.7 |
| Evaluation | Breaking elongation (%) | 358 | 414 | 352 | 301 | 283 |
| | Breaking strength (MPa) | 39.5 | 58.9 | 50.8 | 47.9 | 50.3 |
| | Initial modulus after | 0.3 | 0.9 | 1.3 | 0.5 | 0.5 |
| | immersion (MPa) | | | | | |
| | Peel strength before | 21.5 | 20.0 | 20.2 | 21.4 | 22.5 |
| | immersion (N/25 mm) | | | | | |
| | Peel strength after | 5.2 | 8.4 | 9.8 | 1.5 | 3.2 |
| | immersion (N/25 mm) | | | | | |
| | Peel strength ratio before | 24.2 | 42.0 | 48.5 | 7.0 | 14.2 |
| | and after immersion (%) | | | | | |

TABLE 2

| | | Comparative | Comparative | Comparative | Comparative |
|---|---|---|---|---|---|
| | | Example 1 | Example 2 | Example 3 | Example 4 |
| Acrylic component | (Meth)acrylic monomer | IBXA | ACMO (25 parts) | AA (25 parts) | ACMO (50 parts) |
| | | (100 parts) | IBXA (75 parts) | IBXA (75 parts) | IBXA (50 parts) |
| Urethane component | Polyol (PTMG) | 72.8 parts | 72.8 parts | 72.8 parts | 36.4 parts |
| | Polyisocyanate (HXDI) | 27.2 parts | 27.2 parts | 27.2 parts | 13.6 parts |

| Photopolymerization initiator (Irg651) | | 0.3 parts | 0.3 parts | 0.3 parts | 0.3 parts |
|---|---|---|---|---|---|
| Urethane end reaction additive (HEA) | | 6.5 parts | 6.5 parts | 6.5 parts | 3.3 parts |
| Catalyst (DBTL) | | 0.01 parts | 0.01 parts | 0.01 parts | 0.005 parts |
| Acrylic polymer (% by weight) | | 50 | 50 | 50 | 67.7 |
| Urethane polymer (% by weight) | | 50 | 50 | 50 | 33.3 |
| Water absorption ratio (%) | | 0.9 | 1.4 | 2.9 | 4.6 |
| Evaluation | Breaking elongation (%) | 317 | 374 | 339 | 22 |
| | Breaking strength (MPa) | 42.3 | 53.0 | 59.5 | 18.8 |
| | Initial modulus after immersion (MPa) | 3.7 | 2.5 | 1.0 | 8.5 |
| | Peel strength before immersion (N/25 mm) | 20.0 | 21.3 | 25.0 | 24.0 |
| | Peel strength after immersion (N/25 mm) | 14.5 | 13.1 | 15.2 | 20.2 |
| | Peel strength ratio before and after | 72.5 | 61.5 | 60.8 | 84.2 |
| | immersion (%) | | | | |

As is apparent from Table 1, it was found out that the composite films of Examples 1 to 5 of the present invention had sufficient toughness and flexibility and that, in the pressure-sensitive adhesive tapes using the composite films, peel force after immersion in water also decreased to 50% or less of the initial one. Therefore, it was found that the pressure-sensitive adhesive tapes had sufficient adhesive force at usual use and could be easily peeled off after immersion in water. Namely, when the base materials of Examples 1 to 5 are used as base materials for pressure-sensitive adhesive tapes and pressure-sensitive adhesive sheets, water-immersion peelability, i.e., a property easily peelable by immersion in water, can be imparted with using any pressure-sensitive adhesives freely.

As is apparent from Table 2, the base materials of Comparative Examples 1 to 3 had a small water absorption ratio and a decrease in peel force after water immersion was not sufficient. Moreover, in the case where the acrylic component is in a large amount as in Comparative Example 4, the elongation of the base material decreases and handling becomes difficult. Furthermore, the decrease in peel force after water immersion was also not sufficient.

According to the present invention, there is obtained a pressure-sensitive adhesive tape or pressure-sensitive adhesive sheet which is capable of free design of a pressure-sensitive adhesive without limiting the kind of the pressure-sensitive adhesives and is easily peelable after use with exhibiting a sufficient adhesive force at use.

The present application is based on Japanese Patent Application No. 2009-198387 filed on Aug. 28, 2009, and the contents are incorporated herein by reference.

### INDUSTRIAL APPLICABILITY

The pressure-sensitive adhesive tape or pressure-sensitive adhesive sheet of the present invention is suitably used as a pressure-sensitive adhesive tape or the like which is required to be peeled after use and is also suitable in the fields where recycling is required after use. Moreover, the base material of the present invention is suitably used for the pressure-sensitive adhesive tape or pressure-sensitive adhesive sheet.

1. A base material for pressure-sensitive adhesive tape or pressure-sensitive adhesive sheet, the base material being a composite film containing a urethane polymer having an acryloyl group at its molecular chain end and a (meth)acrylic polymer, wherein the composite film has a water absorption ratio of 5% or more.

2. The base material for pressure-sensitive adhesive tape or pressure-sensitive adhesive sheet according to claim 1, wherein a (meth)acrylic monomer for forming the (meth)acrylic polymer contains at least one compound selected from the group consisting of (meth)acrylic acid and (meth)acryloylmorpholine.

3. The base material for pressure-sensitive adhesive tape or pressure-sensitive adhesive sheet according to claim 2, wherein the (meth)acrylic monomer for forming the (meth)acrylic polymer contains (meth)acrylic acid and isobornyl acrylate, or (meth)acryloylmorpholine and isobornyl acrylate.

4. The base material for pressure-sensitive adhesive tape or pressure-sensitive adhesive sheet according to claim 1, wherein a content of the urethane polymer is 40 parts by weight or more based on 100 parts by weight of total weight of the urethane polymer and the (meth)acrylic polymer.

5. A pressure-sensitive adhesive tape or pressure-sensitive adhesive sheet comprising a pressure-sensitive adhesive layer on one surface of the base material according to claim 1.

6. A process for producing a base material for pressure-sensitive adhesive tape or pressure-sensitive adhesive sheet as a composite film, comprising:
a step of reacting a polyol with a polyisocyanate in one or more (meth)acrylic monomers to form a urethane polymer, and
a step of applying a mixture containing the (meth)acrylic monomer and the urethane polymer on a support and irradiating the mixture with light to form an acrylic polymer,
wherein the composite film having a water absorption ratio of 5% or more is obtained.

7. The process for producing a base material for pressure-sensitive adhesive tape or pressure-sensitive adhesive sheet according to claim 6, wherein the (meth)acrylic monomer contains at least one compound selected from the group consisting of (meth)acrylic acid and (meth)acryloylmorpholine.
